(19) United States
(12) Patent Application Publication
(10) Pub. No.: US 2019/0377069 A1
(43) Pub. Date: Dec. 12, 2019

(54) RECEIVING DEVICE FOR A LIDAR SYSTEM

(71) Applicant: Robert Bosch GmbH, Stuttgart (DE)

(72) Inventor: Tobias Peterseim, Boeblingen (DE)

(21) Appl. No.: 16/432,323

(22) Filed: Jun. 5, 2019

(30) Foreign Application Priority Data
Jun. 6, 2018 (DE) 102018208897.7

(51) Int. Cl. G01S 7/481; G02B 5/28; G02B 5/08

(52) U.S. Cl. CPC G01S 7/4816; G02B 5/08; G02B 5/28

(57) ABSTRACT

A receiving device for a lidar system includes: a limiting device for limiting an angle of entrance of a received optical beam; two reflector elements; and a detector element, where the received optical beam can impinge upon the limiting device and the first refracting element and the two reflector elements are formed and aligned with each other such that the received beam is foldable in relation to an axis of the received optical beam and guidable onto the detector element.

### CROSS-REFERENCE TO RELATED APPLICATIONS

The present application claims priority under 35 U.S.C. § 119 to DE 10 2018 208 897.7, filed in the Federal Republic of Germany on Jun. 6, 2018, the content of which is hereby incorporated by reference herein in its entirety.

### FIELD OF THE INVENTION

The present invention relates to a receiving device for a lidar system. The present invention further relates to a method for manufacturing a receiving device for a lidar system.

### BACKGROUND

Different variants of 3-D optoelectronic scanners are known. These are understood to include rotating macroscanners, MEMS-based scanners, OPA (optical phase array) lidar, and flash lidar. What all of the above-mentioned systems have in common is that they collect emitted laser light. In this context, there are optical systems that are made up of one lens or a plurality of lenses. What they all have in common is that they have a long optical receiving path, that is, a large number of lenses.

In this manner, a beam having a diameter in the centimeter range can be guided in the transmission path via the rotating macromirror. Using such systems, in which all of the components “rotate,” it is inherent to the system that a horizontal field of view (FOV) of 360° can advantageously be scanned.

An optical detection system, which is made up of a lens system and forms an image of and/or focuses incident light on individual receivers, is known, e.g., from DE 10 2012 006 869 A1.

EB 2 955 558 A1 describes a lens system, as is or that can be used in a lidar system, the lens system including at least seven lenses.

DE 10 2011 107 585 A1 likewise describes a single lens, which is used in a lidar system in order to receive and emit light.

Current imaging systems or objectives are made up mostly of only individual lenses, which are generally optically transparent to the wavelengths stipulated by the scanner, and whose surfaces are shaped in such a manner that, when they function individually or cooperate, they guide the incident light to, and form an image of it on, the detector.

Most of these known systems have a considerable overall length. They react sensitively to temperature changes as a function of the lens material used (e.g., glass or plastic) and the selection of the housing material, which means that the optical efficiency and imaging capability suffer. This often has a direct effect on the range and resolution of such scanners. These objectives have a high weight due to the lens material.

### SUMMARY

An object of the present invention is to provide improved receiving optics for a lidar system.

According to a first aspect, the present invention provides a receiving device for a lidar system, where the receiving device includes: a limiting device for limiting an angle of entrance of a received optical beam; two reflector elements; and a detector element, where the received optical beam of the lidar system is able to impinge upon the limiting device, the first refracting element and the two reflector elements are formed and aligned with each other in such a manner that the received beam of the lidar system is foldable in relation to an axis of the received optical beam and guidable onto the detector element.

Due to the fact that air is present between the reflector elements, this keeps the overall length of the receiving device low. In this manner, the entire receiving device can advantageously take up less space and consequently become lighter, as well. In this manner, the receiving optics are advantageously less sensitive to temperature fluctuations. In addition, the focal point is advantageously not shifted, which means that chromatic aberration of the receiving device is prevented to the greatest extent possible.

According to a second aspect, the object is achieved by a method of manufacturing a receiving device for a lidar system, including the steps of: providing a limiting device for limiting an angle of entrance of a received optical beam; providing two reflector elements; and providing a detector element, where the limiting device is formed such that a received beam can impinge upon it and the receiving device and the two reflector elements are formed and aligned with each other such that the received beam of the lidar system is foldable in relation to an axis of the received optical beam and guidable onto the detector element.

In an example embodiment of the receiving device, a first reflector element includes spherical and conical portions. In this manner, from a standpoint of production engineering, this allows the receiving device to be manufactured more easily and cost-effectively.

In an example embodiment of the receiving device, the first reflector element includes aspherical portions. In this manner, from a standpoint of production engineering, this allows the receiving device to be manufactured in a further improved manner.

In an example embodiment of the receiving device, the detector element is situated in a central, recessed region of the first reflector element. In this manner, a chromatic aberration of the receiving device can advantageously be eliminated to the greatest extent possible; spots always being imaged identically, substantially independently of the angle of arrival of the laser beam.

In an example embodiment of the receiving device, a second refracting element is situated in a central, recessed region of the first reflector element. In this manner, the imaging quality of the receiving device can again be increased markedly; in particular, this allows even smaller spot sizes to be achieved.

In an example embodiment of the receiving device, the second reflector element is situated on the limiting device. In this manner, a smaller spot radius can be produced over the entire field of view.

In an example embodiment of the receiving device, the reflector elements are formed as specularly reflecting surfaces. This provides technically simple options for manufacturing the reflector elements.

In an example embodiment of the receiving device, the reflector elements are formed as specularly reflecting surfaces on surfaces of the limiting device. In this manner, the receiving device is essentially made up of a single element, which simplifies an installation and adjustment operation considerably. Through this, a particularly low space requirement of the receiving device is advantageously achieved.

In an example embodiment of the receiving device, the specularly reflecting surfaces each has a band-pass filter element, in particular, an interference filter. In this manner, a narrow-band characteristic of the receiving device is supported, which means that interfering background light can be substantially eliminated.

In the following, the present invention, including further features and advantages, is described in detail in light of a number of figures, in which identical or functionally equivalent components have the same reference numerals. In particular, the figures are meant to clarify certain principles of the present invention and are not necessarily drawn true to scale.

Device features described follow analogously from corresponding method features described, and vice versa. This means, in particular, that features, technical advantages, and explanations regarding the receiving device for a lidar system follow analogously from corresponding explanations, features, and advantages of the method of manufacturing a receiving device for a lidar system, and vice versa.

### BRIEF DESCRIPTION OF THE DRAWING

FIG. 1 is a basic representation of a receiving device for a lidar system according to an example embodiment of the present invention.

FIG. 2 is a basic representation of a receiving device for a lidar system according to another example embodiment of the present invention.

FIGS. 3 and 4 are basic views of a receiving device for a lidar system according to another example embodiment of the present invention.

FIG. 5 is a basic representation of a receiving device for a lidar system according to another example embodiment of the present invention.

FIG. 6 is a block diagram of a lidar system including a receiving device according to an example embodiment of the present invention.

FIG. 7 is a flowchart that illustrates a method of manufacturing a receiving device for a lidar system, according to an example embodiment of the present invention.

### DETAILED DESCRIPTION

A central idea of the present invention is, in particular, to provide improved receiving optics for a lidar system.

A receiving device for, e.g., a 3-D optoelectronic scanner having specularly reflecting surfaces is provided, the specularly reflecting surfaces being able to be produced, for example, by depositing metal (e.g., in the form of silver, aluminum, gold, etc.). In addition, by optionally depositing a dielectric layer on the specularly reflecting surfaces, a wavelength-selective mirror can be produced, which can act simultaneously as an optical filter in the 3-D scanner and help to suppress or minimize interfering background light.

Due to this, the medium that fills the space between the mirrors is air. However, there is the option of filling up this space with another optically transparent medium (e.g., glasses, such as BK7; plastics, such as polycarbonate, zeonex, etc.; liquids, such as oils). In this last-mentioned, monolithic set-up, the boundary surfaces are plated with the above-mentioned, specularly reflecting layers, so that these have reflecting characteristics for the corresponding wavelengths. In this context, the entrance surfaces themselves of this monolith can have optical beam-shaping characteristics. An advantage of such a set-up is an extremely compact design of the receiving device.

FIG. 1 shows a first example embodiment of a proposed receiving device 100 for a lidar system. A laser light beam reflected by a target object (not shown) strikes a first reflector element 10, which reflects it onto a second reflector element 11. The received beam is guided by second reflector element 11 to a detector element 20, which is situated in a central, recessed portion of first reflector element 10. In this manner, receiving device 100 mainly encompasses air between reflector elements 10, 11, through which a temperature sensitivity of the entire receiving device 100 is advantageously reduced. The axial folding of the received beam, which is achieved in this manner and based on an axis of the received beam, additionally allows the space taken up by receiving optics 100 to be advantageously reduced, and consequently allows a compact design of the receiving optics to be implemented. A limiting device 1 in the form of an entrance aperture limits the angle of entrance of incident, received optical beams.

The surfaces of reflector elements 10, 11 are spherical and can include an additional conical portion. Also, the surfaces of reflector elements 10, 11 can optionally include aspherical portions. Detector element 20 can take the form of a 0-D (single-pixel) detector, 1-D array or 2-D array detector (CCD, CMOS imager, PIN diodes, APD (avalanche photodiode), SPAD (single photon avalanche diode), etc., which can be made up of one or more pixels. A plurality of 0-D detectors can also be arranged in an arbitrary pattern so as to have a particular spatial separation perpendicular to the beam direction.

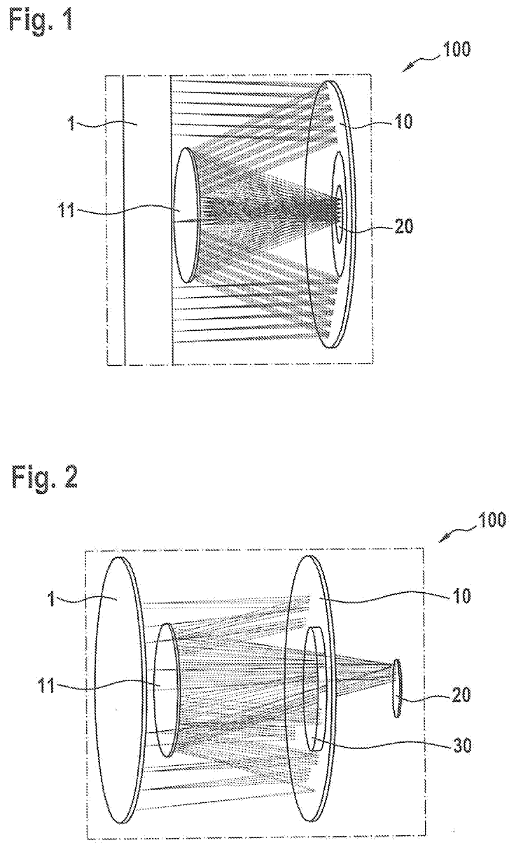

FIG. 2 shows a cross-sectional view of a further example embodiment of a proposed receiving device 100 for a lidar system. In this set-up, a refracting element 30 is situated in the central, recessed region of first reflector element 10, the refracting element guiding and/or focusing the received-beam laser light reflected by second reflector element, onto the detector element 20 behind first reflector element 10.

This configuration allows an imaging quality (e.g., spot radius) to increase even further in comparison with the set-up of FIG. 1. In this variant, as well, the surfaces of reflector elements 10, 11 include a spherical and a conical portion and also, optionally, an aspherical portion. Refracting element 30 is preferably formed to be aspherical on both surfaces. For example, N-BK7 can be provided as material for second reflector element 11. However, any other lens material can also be used in an advantageous manner. In this case, limiting device 1 is configured as an optical element in the form of a refracting element.

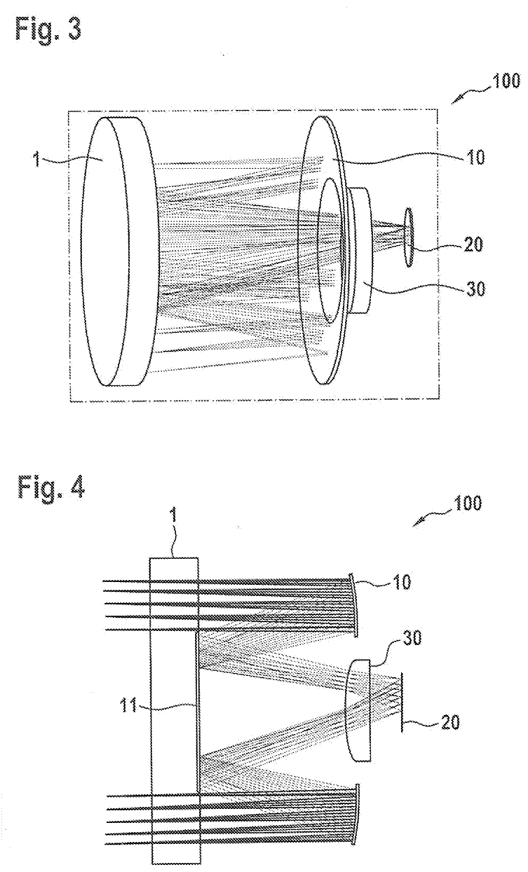

FIG. 3 shows a perspective view of a further example embodiment of a proposed receiving device 100 for a lidar system. A reflector system having two reflector elements 10, 11 and two lens elements 1, 30 can be seen; second reflector element 11 being formed on a surface of the limiting device 1 facing first reflector element 10, the limiting device being configured as a refracting element. Refracting element 1 preferably has a spherical and a conical portion, and optionally, an aspherical portion, as well. The surfaces of reflector elements 10, 11 have a spherical and a conical portion. A further refracting element 30, which is preferably aspherical on both surfaces, is situated in front of a central, recessed region of first reflector element 10.

The lens material of refracting elements 1, 30 is preferably made up of the material N-BK7, but any other lens material can also be used.

FIG. 4 shows a cross-sectional view of the set-up of FIG. 3; from the figure, it being even more discernible that second reflector element 11 is situated on a surface of the limiting device 1 taking the form of a refracting element. For example, second reflector element 11 can be embedded in the surface of refracting element 1 or deposited onto the surface of refracting element 1.

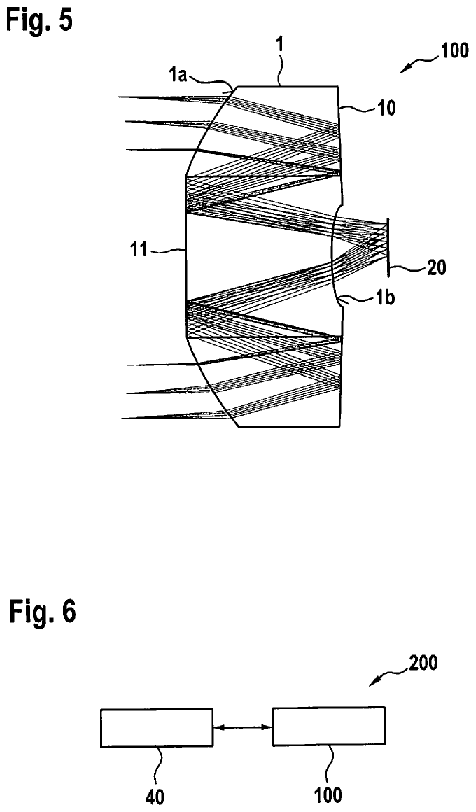

FIG. 5 shows a cross section of a further example embodiment of a proposed optical receiving device 100 for a lidar system. In this case, receiving device 100 takes the form of a monolithic lens-mirror system; reflector elements 10, 11 being situated on surfaces of the limiting device 1 in the form of a refracting element. The refracting element of limiting device 1 is preferably made of BK7 material, but any other material suitable for optical systems is also conceivable. The above-mentioned material fills in the region between the refracting surfaces and reflector elements 10, 11. A refracting surface 1a and first reflector element 10 of limiting device 1 are made up of a spherical and a conical portion. Second reflector element 11 is situated on a flat surface of the refracting element of limiting device 1. The received beam is guided or focused by second reflector element 11 onto the detector element 20 situated outside of first refracting element 1.

Therefore, receiving device 100 of FIG. 5 is made up essentially of only a single element, which simplifies an installation and/or adjusting operation of receiving device 100 considerably.

For all of the example embodiments mentioned above, an f-number lies, for example, in a range of approximately 1.15 to approximately 1.20, preferably in a range of approximately 1.16 to 1.18. A spot size of an image point increases from a few micrometers at a 0° object angle to approximately 1200 μm at a 4.5° object angle. In particular, the set-up of FIG. 2 can produce a spot size of image points that is markedly improved over the FOV. In all of the receiving devices explained, the FOV is approximately 9°. A distortion of all of the above-mentioned receiving devices is, by way of example, less than 1%. However, all of the numerical values mentioned are only illustrative.

The proposed, reflector-based receiving devices 100 permit effective imaging within a FOV of ±5°, the FOV being able to be expanded by a combination of a plurality of these objectives, the individual objectives being able to be positioned at a suitable angle to each other, so that as a result, a greater FOV can be produced. In this case, the term “objective” stands for a reflector-based receiving device.

The proposed receiving devices can be used for biaxial and coaxial flash lidar; macroscanners, in which the receiving unit and/or transmitting unit are rotated along or only one rotating reflector deflects the transmitted and received laser light onto the static transmitting and receiving units; FMCW lidar; MEMS lidar; OPA lidar; etc.

Proposed receiving devices 100 are suited to different variants of 3-D optoelectronic scanners, as desired. If the resolution of the surrounding area is produced on the imager/detector, which is made up of a plurality of pixels (e.g., CCD, CMOS imagers, 2-D and line detectors, SPAD and APD), then the image point should range in the magnitude of the pixel size. In particular, receiving devices 100 of FIGS. 2-5 can be used for this.

If the spatial resolution is no longer generated on the receiving side, but, for example, using temporally staggered firing of laser light pulses, then, as a rule, larger pixels, on which a plurality of object points are imaged, are used, in this case, a poorer resolution of the lens systems being sufficient. Such a system is represented, for example, by receiving device 100 in FIG. 1.

The proposed, reflector-based receiving devices 100 advantageously have a nearly constant imaging quality as a function of the wavelength and can therefore be adapted for different wavelengths without modification of the optical design.

All of the optical systems portrayed in FIGS. 1-5 can advantageously be designed for a 905 nm wavelength, but can be adapted, in the same set-up, to other wavelengths using optimization methods. In the receiving devices proposed, the receive aperture is, for example, approximately 30 mm.

FIG. 6 shows a block diagram of an example embodiment of a lidar system 200, including a laser element 40, which interacts functionally with receiving device 100 in the manner described above.

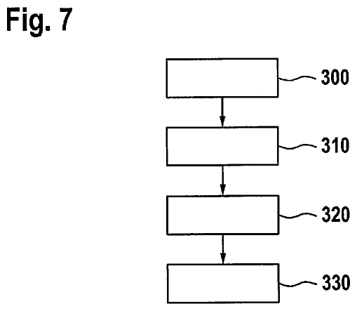

FIG. 7 shows a basic flowchart of a method of manufacturing a receiving device 100 for a lidar system 100, according to an example embodiment of the present invention. In a step 300, a limiting device 1 for limiting an angle of entrance of a received optical beam is provided. In a step 310, two reflector elements 10, 11 are provided. In a step 320, a detector element 20 is provided. In a step 330, limiting device 1 is configured such that a received beam of lidar system 200 can impinge upon it; limiting device 1 and the two reflector elements 10 being formed and aligned with each other such that the received beam of lidar system 200 is foldable in relation to an axis of the received optical beam and guidable onto detector element 20.

In summary, the present invention provides reflector systems that can be combined with lenses. In this manner, structurally smaller and lighter scanners can advantageously be produced, which are less sensitive to changes in the operating temperature.

It is clear to one skilled in the art that numerous modifications to the present invention are possible without departing from the essence of the invention.

What is claimed is:

1. A receiving device for a lidar system, the receiving device comprising:
an optical limiter, wherein the optical limiter is designed for limiting an angle of entrance of a received optical beam;
a first reflector;
a second reflector; and
a detector;
wherein:
the optical limiter is arranged so that the received optical beam of the lidar system is able to impinge upon the optical limiter; and
the optical limiter and the reflectors are aligned relative to one another to fold the received optical beam onto the detector.

2. The receiving device of claim 1, wherein the first reflector includes spherical and conical portions.

3. The receiving device of claim 2, wherein the first reflector includes aspherical portions.

4. The receiving device of claim 2, wherein the detector is situated in a central recessed region of the first reflector.

5. The receiving device of claim 2, wherein a refractor is situated in a central recessed region of the first reflector.

6. The receiving device of claim 1, wherein the second reflector is situated on the optical limiter.

7. The receiving device of claim 1, wherein the reflectors include as specularly reflecting surfaces.

8. The receiving device of claim 7, wherein the specularly reflecting surfaces each includes a band-pass filter.

9. The receiving device of claim 8, wherein band-pass filter is an interference filter.

10. The receiving device of claim 1, wherein the reflectors include specularly reflecting surfaces and are formed on surfaces of the optical limiter.

11. A method of manufacturing a receiving device for a lidar system, the method comprising:
providing an optical limiter for limiting an angle of entrance of a received optical beam that impinges upon the optical limiter;
providing a first reflector and a second reflector;
aligning the optical limiter and the reflectors relative to one another to fold the received optical beam onto the detector.

12. A 3-D optoelectronic scanner comprising a lidar system, the lidar system including a receiving device, the receiving device comprising:
an optical limiter, wherein the optical limiter is designed for limiting an angle of entrance of a received optical beam;
a first reflector;
a second reflector; and
a detector;
wherein:
the optical limiter is arranged so that the received optical beam of the lidar system is able to impinge upon the optical limiter; and
the optical limiter and the reflectors are aligned relative to one another to fold the received optical beam onto the detector.
